(19) United States
(12) Patent Application Publication
(10) Pub. No.: US 2024/0246255 A1
(43) Pub. Date: Jul. 25, 2024

(54) DOORS AND SYSTEMS AND METHODS OF MAKING THE SAME

(71) Applicant: Masonite Corporation, Tampa, FL (US)

(72) Inventors: Bei-Hong LIANG, Naperville, IL (US); James P. PFAU, Kirkland, IL (US); Steve B. Swartzmiller, Batavia, IL (US); Robert C. ALLEN, Elburn, IL (US); Ziqiang LU, Aurora, IL (US)

(21) Appl. No.: 18/428,999

(22) Filed: Jan. 31, 2024

Related U.S. Application Data
(63) Continuation of application No. 18/422,784, filed on Jan. 25, 2024.
(63) Continuation of application No. 18/426,941, filed on Jan. 30, 2024.
(60) Provisional application No. 63/442,172, filed on Jan. 31, 2023.
(60) Provisional application No. 63/440,989, filed on Jan. 25, 2023.
(60) Provisional application No. 63/441,922, filed on Jan. 30, 2023.

(51) Int. Cl. B27G 11/00; E06B 3/70

(52) U.S. Cl. CPC B27G 11/005; E06B 3/7001; E06B 2003/7019; E06B 2003/7046

(57) ABSTRACT

Half doors, doors, systems and methods of making the same are described, including use of an adhesive that is capable of achieving green strength in a predetermined time, including for exemplary automated embodiments, to prevent movement of the components relative to each other.

### CROSS REFERENCE TO RELATED APPLICATIONS

This application claims priority to U.S. Provisional Application No. 63/442,172 filed Jan. 31, 2023; and is a continuation of U.S. application Ser. No. 18/422,784 filed Jan. 25, 2024 which claims priority to U.S. Provisional Application 63/440,989 filed Jan. 25, 2023 and is a continuation of U.S. application Ser. No. 18/426,941 filed Jan. 30, 2024 which claims priority U.S. Provisional Application No. 63/441,922, filed Jan. 30, 2023, the disclosure of which is incorporated herein by reference.

### FIELD

This invention relates to doors, and to systems and methods of making the same.

### BACKGROUND

Solid, natural wood provides aesthetic qualities that are desirable to many consumers and therefore preferred for various products. However, solid, natural wood is a relatively expensive material, and thus products made from solid, natural wood generally are more expensive than products made from alternative materials such as plastics or wood composites. As the price of natural wood has increased, the market for manufactured products that simulate natural wood has grown.

The door market is an example of a market in which natural wood has been replaced with simulated wood and other materials. Assembled doors simulating natural wood doors are well known in the art. Such doors typically include a peripheral frame and two door facings (also known in the art and referred to herein as door skins) respectively secured to opposing surfaces of the frame. The door facings may be formed from wood composite, such as hardboard, medium density fiberboard (MDF), oriented strand board, wood-plastic composites, etc. It is also known to form door facings from sheet molding compounds (SMCs) containing a thermosetting polymer and fiberglass, and from thermoplastic compounds typically reinforced with fiberglass. Steel and other metals are further examples of alternative materials from which the door facings may be made.

The entirety of the exterior surfaces of the door facings may be planar (or “flush”) so as to lie in a single plane. Alternatively, the exterior surfaces of the door facings may include transition regions or contoured regions surrounding panels, which typically are either coplanar with or recessed from the main body area of the door facing surrounding the transition/contoured regions. The main body area of the door facings surrounding the panels and transition regions is often designed with woodgrain patterns arranged perpendicularly to simulate stiles and rails, as found in traditional rail-and-stile solid wood doors. The exterior surface of the door facings may be smooth, or they may be textured, for example, to provide for the appearance of woodgrain and optionally wood background tones.

Typically, the peripheral frame and the door facings define an internal cavity that may include a core. It is desirable for the core to provide rigidity and structural integrity to the door, as well as thermal and acoustic characteristics. To achieve those properties, the core often is made to fill the entire internal cavity. One way of filling the internal cavity with a core is to inject expanding foam through one or more holes drilled in the peripheral frame, and allow the foam to expand and cure.

Another option for filling the internal cavity of the door is to provide a prefabricated solid core. The prefabricated solid cores require machining (e.g., routing) or other shaping of the opposing surfaces of the core to match thickness variations in the internal cavity due to the contours of the transition regions and recessing of the panels of the door facings. The prefabricated solid cores cannot be universally applied to a wide variety of door designs and must be tailored for each door design.

Door assembly in any form presents a number of challenges in order to present a quality product without noticeable defects, which may be caused from a variety of factors, e.g., warping of skins during application of those skins (with warping occurring generally because of temperature or humidity, based on delay of application or inaccurate application of facings, or skins, etc.), general delay during assembly of components, including core components, lack of adhesive bonding or incomplete or delayed bonding between components during assembly, etc. Further, the same core or core components be used for different door skin designs. Importantly, the core and core components should not cause distortion on the surface of the door. It is, therefore, desirable to have a core and core components that may be used for different door designs while causing no noticeable distortion in the final door product.

What is needed in the art are techniques for door manufacturing that alleviate the problems and deficiencies of the prior art.

### SUMMARY

The present disclosure overcomes the problems and disadvantages in the prior art by providing doors and systems and methods for assembly of doors, wherein the components to be assembled can advantageously be maintained in position, without shifting, as the door being assembled is being transported along the assembly line.

To maintain the position of the components relative to each other, the present disclosure describes use of an adhesive that is capable of quickly achieving green strength (as defined below) to prevent movement of the components relative to each other. The time to achieve green strength may be controlled by the manner in which the adhesive is applied to the door components and also by appropriately selecting the adhesive(s).

In exemplary aspects described herein, systems and methods for assembling doors use particular adhesive properties and particular timings for both laying down adhesive and achieving green strength during assembly.

In further exemplary aspects described herein, automated systems and methods for door assembly include predetermined times for applying adhesive during automated assembly steps, combined with adhesive property aspects determined by the present disclosure to be advantageous for assembly of half doors and doors in order to minimize or to eliminate defects and to ensure quality of construction during such assembly.

In further exemplary aspects, with regard to adhesives, a polyurethane reactive (PUR) adhesive is utilized.

In exemplary aspects, a method includes applying a first adhesive to a first surface of a frame including first surfaces of plural stiles and rails; assembling the first surface of the frame, including the stiles and rails, on an interior surface of a first door skin to assemble a half door, wherein the first adhesive is a hot melt adhesive configured to achieve green strength within a predetermined time to prevent movement of components relative to one another; pressing the half door; applying a second adhesive to the interior surface of the first door skin; positioning a first surface of one or more core inserts, lock blocks or locking components on the second adhesive on interior surface of the first door skin; applying a third adhesive to an interior surface of a second door skin or to a second surface of the frame and the one or more core inserts, lock blocks or locking components; placing the second door skin on the frame to form a complete door assembly; and pressing the complete door assembly.

Other exemplary aspects are described below relative to various exemplary steps for assembly of a door, including further adhesive options, application and pressure timings for such steps (e.g., for application of a second door skin), finishing options, core component options, door skin styles and options, etc.

### BRIEF DESCRIPTION OF THE DRAWING(S)

The accompanying drawings are incorporated in and constitute a part of the specification. The drawings, together with the general description given above and the detailed description of the exemplary embodiments and methods given below, serve to explain the principles of the invention. In such drawings:

FIG. 1 is a front perspective view of an exemplary door;

FIG. 2 is a plan view of the door of FIG. 1 with the first door facing removed;

FIG. 3 is a cross-section of the door of FIG. 1 taken along sectional line 3-3 (shown in FIG. 2);

FIG. 4 is an exploded view of FIG. 3;

FIG. 5 is a cross-section of the door of FIG. 1 taken along sectional line 5-5 (shown in FIG. 2);

FIG. 6 is an exploded view of FIG. 5; and

FIG. 7 is a flow diagram showing exemplary steps in forming the door;

FIG. 8 is a cross-section showing the placement of an exemplary frame on the first door facing;

FIG. 9 is a cross-section showing exemplary placement of the core inserts on the first door facing;

FIG. 10 is a drawing of the exemplary core insert with adhesive thereon;

FIG. 11 is a photograph of an exemplary first door facing with a plurality of core inserts thereon;

FIG. 12 is a cross-section showing exemplary assembly of the second door facing; and

FIG. 13 is a photograph showing an exemplary half door of an embodiment where a large core insert substantially fills a recessed door panel.

### DETAILED DESCRIPTION

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods.

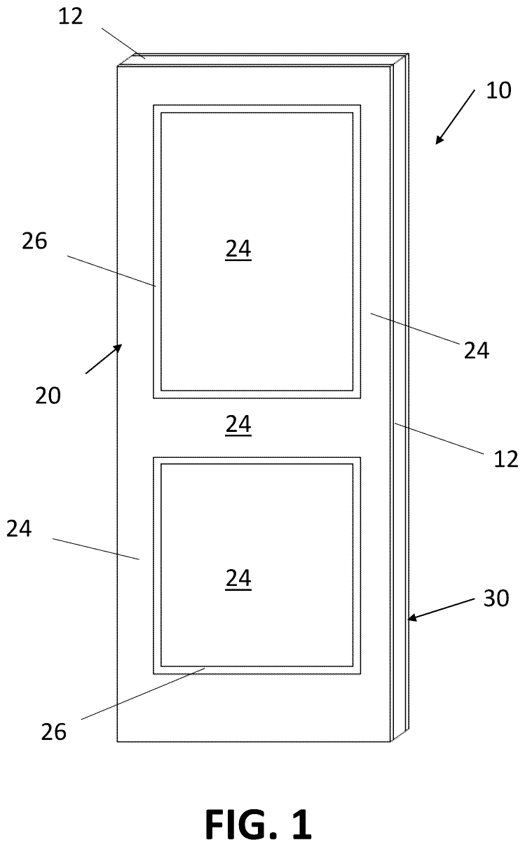

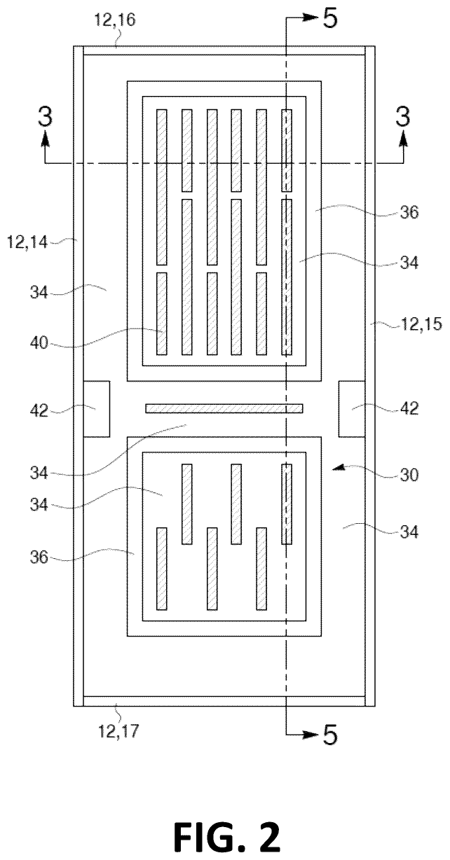

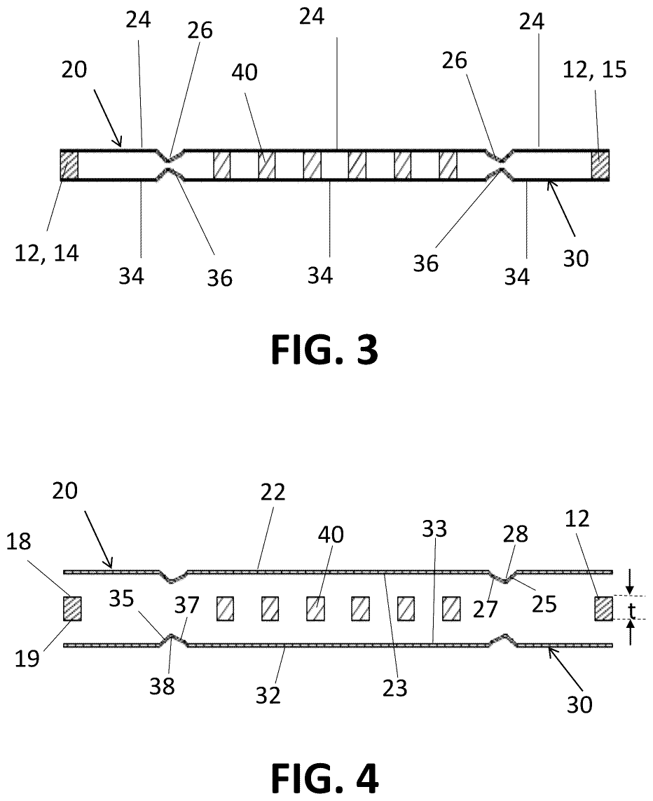

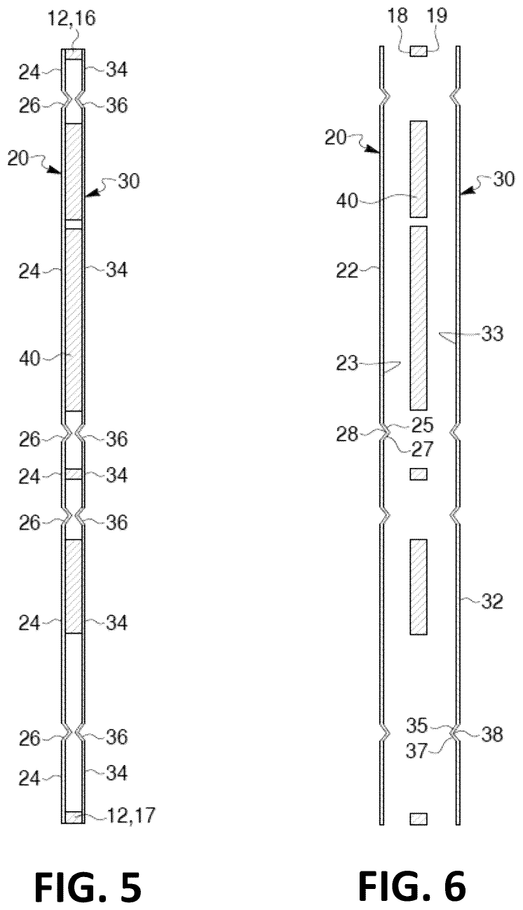

As best shown in FIGS. 1 through 6, exemplary door 10 includes a peripheral frame 12. The frame 12 includes stiles 14 and 15 (shown in the cross section of FIGS. 2 and 3) and top and bottom rails 16 and 17 (shown in cross section in FIGS. 2 and 3-6) connecting the ends of the stiles 14 and 15. Although not shown, the frame 12 may include intermediate rails (extending between and parallel to the rails 16 and 17). The frame 12 may also include one or more lock blocks 42 (see FIG. 2). As best shown in FIGS. 4 and 6, the frame 12 has a first surface 18 and a second surface 19 opposite to the first surface 18. The frame 12 may be made of, for example, wood, metal, composite (such as MDF), other materials, or a combination thereof.

The exemplary door 10 further comprises a first door facing 20 and a second door facing 30. The first and second door facings 20 and 30 may be made of, for example, wood composite (e.g., MDF), fiberglass-reinforced thermoset, such as a sheet molding compound (SMC), fiberglass-reinforced thermoplastic, steel, or other materials. The first and second door facings 20 and 30 are typically made of the same materials and typically are identical to one another, including having the same appearance and thickness.

As best shown in FIG. 4, an exemplary first door facing 20 has a first exterior (or exteriorly disposed) surface 22 and an opposite first interior (or interiorly disposed) surface 23. The first interior surface 23 is secured at its periphery to the first surface 18 of the frame 12. Similarly, an exemplary second door facing 30 has a second exterior (or exteriorly disposed) surface 32 and an opposite second interior (or interiorly disposed) surface 33. The second interior surface 33 is secured at its periphery to the second surface 19 of the frame 12. The first and second exterior surfaces 22 and 32 face away from (oppose) one another, while the first and second interior surfaces 23 and 33 face toward one another. The first and second door facings 20 and 30 may be secured to the first and second surfaces 18 and 19 of the frame 12 using adhesive, mechanical fasteners, a combination thereof, or another suitable securing technique. Preferably, adhesive is used to secure the door facings 20 and 30 to the frame 12.

In certain exemplary embodiments, the first and second door facings 20 and 30 may include different regions forming panels in the door. The door 10 shown in FIGS. 1-6 includes paneled door facings 20, 30 having raised regions 24, 34 that are connected by recessed regions 26, 36. Preferably, the door facings 20, 30 are mirror images of each other. The first door facing 20 has raised regions 24 that are coplanar with each other, and recessed regions 26 that are recessed from the raised regions 24. The raised regions 24 form panels. Each of the recessed regions 26 preferably contains a first slope 25 and a second slope 27 (see FIGS. 4 and 6). The first and second slopes 25 and 27 are directly connected to each other and meet at a bottom 28 of the recessed region 26, with the first slope 25 continuous with and connected to the first raised portion 24 and the up slope 27 continuous with and connected to the second raised portion 24. The second door facing 30 is a mirror image of the first door facing and similarly contains its own raised regions 34, recess regions 36, first slope 35, second slope 37, and bottom 38. Overall, the recessed regions 26, 36 of the first and second door facings 20, 30 connect adjacent raised portions 24, 34, respectively. The slopes 25, 27, 35, 37 may be a straight line directly to the bottom 28, 38 or may include contours as they recess to the bottom 28, 38. The bottoms 28, 38 may be substantially V-shaped as illustrated in FIGS. 3-6; however, the present invention also contemplates bottoms 28, 38 containing other shapes, such as U-shape. The distance between the interior surfaces 23, 33 at the recessed regions 26, 36 is less than at the raised regions 24, 34, preferably about 0.600 inch (1.52 cm) to about 0.880 inch (2.24 cm) or less.

The raised regions 24, 34 form co-planar panels on the door 10. FIGS. 1-6 shows a two-panel door, where a raised region 24, 34 forming a panel with a recessed region 26, 36 surrounds the panel. Although FIGS. 1-6 depict a two-panel door, a skilled person in the art will recognize that doors with other panel configurations, such as one, three, four, five, six, or more panels, may similarly be formed with raised regions 24, 34 forming the panels, while recessed regions 26, 36 surround the raised regions 24, 34. Similarly, while the door 10 has raised panels 24, 34, the principles apply to a door having recessed panels.

The exemplary first and second door facings 20 and 30 of FIGS. 1-6 have identical configurations, as best shown in the cross-sectional views of FIGS. 3-6. The raised region 24, 34 of the first and second door facings 20, 30 are aligned with each other; and the recessed regions 26, 36 of the first and second door facings 20, 30 are aligned with each other.

Although the first and second door facings 20 and 30 are each shown with raised panels, a skilled person in the art would recognize that the panels may be formed with recessed panels, such as that of a shaker door. Each of the door facings may include one more recessed panels. Moreover, while the panels are shown as being rectangular, those skilled in the art will recognize that they may have any configuration, such as being oval.

The door 10 may further include a plurality of exemplary core inserts 40 positioned between the raised portions 24 and 34. However, because the recess regions 26, 36 include no horizontally planar recess portions, in exemplary embodiments, core inserts 40 are not placed between the recess regions 26 and 36. The core inserts 40 are preferably made of corrugated paper core or other suitable material, e.g., expanded polystyrene (EPS). The thickness of the core inserts 40 is preferably the same nominal thickness t as the frame 12 (see FIG. 4). More preferably, the thickness of the core inserts 40 has a range of about 1.110 to about 1.140 inches. Each core insert 40 also has a width approximately equal to the thickness, preferably about 1.110 to about 1.140 inches, and a length of about 10±0.0625 inches or about 19±0.0625 inches. Preferably a core insert 40 has dimensions of 1.125 inches×1.125 inches×10 inches. While the illustrated exemplary core inserts 40 are rectangular in plan, they may have other shapes, such as circular, oval, triangular, etc., provided that they span and are securable to the opposed door facings 20, 30 in order to provide support thereto.

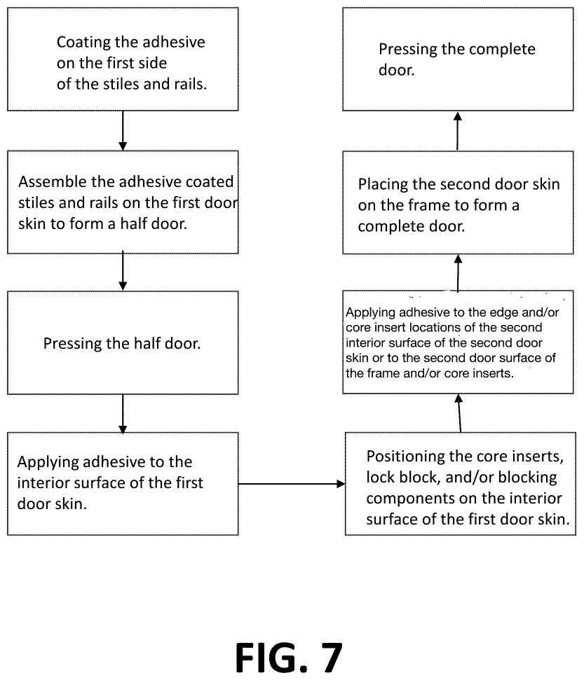

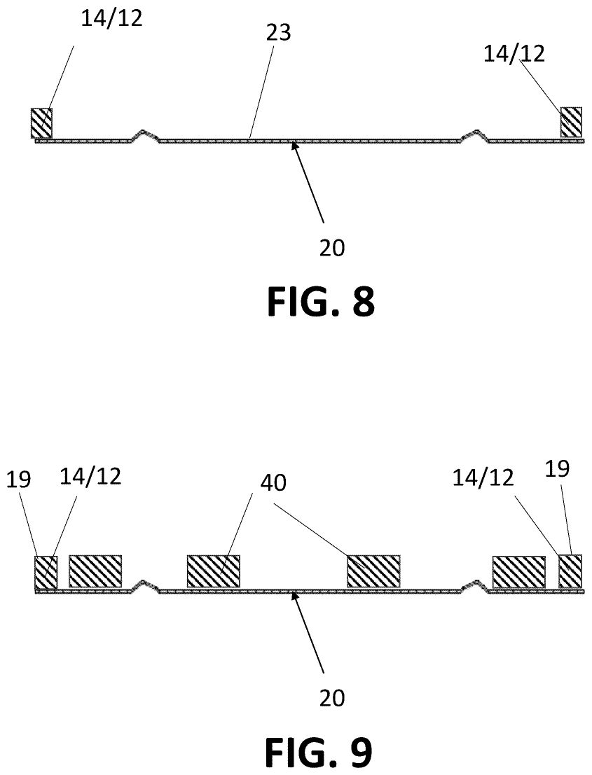

FIG. 7 illustrates an exemplary process for assembling the door 10. An adhesive is coated on to the first side 18 of the stiles and rails 16, 17 and stiles 14, 15. In exemplary embodiments, the adhesive is roll coated onto the surfaces 18 in order to coat substantially the entirety of each surface, and thus achieve maximum surface area. The frame or frame components, including e.g., rails 16, 17 and stiles 14, 15 are then placed onto the first door skin 20, such as through use of a robot, such that the first surfaces 18 of the rails 16, 17 and stiles 14, 15 come into contact with the interior surface 23 of the first door skin 20 (see FIG. 8) to assemble a half door. In the half door, the rails 16, 17 and stiles 14, 15 are assembled in their respective position to form the frame 12.

The half door is then pressed, preferably in a press, under pressure, e.g., at about 100 PSI, to allow the frame 12 and first door skin 20 to come into intimate contact with each other, and for a period sufficient to allow the adhesive to develop green strength sufficient to maintain the first door skin 20 and frame 12 in their positions throughout the assembly process of door 10. Green strength is achieved when the adhesive has reached sufficient bonding strength to prevent movement of the door facing(s), frame, and core insert(s) relative to each other and to hold the door components together for further handling.

In exemplary embodiments, after pressing, adhesive is applied to the interior surface 23 of the first door skin 20. The core inserts 40 are then positioned on the adhesive coated portions of the interior surface 23, as shown in FIG. 9, through use of a robot. At the same time, any exemplary lock block 42 may also be positioned on the adhesive coated interior surface 23.

Once the core inserts 40 (and the lock block 42) are positioned on the first door skin 20, adhesive is applied to the second interior surface 33 of the second door skin 30. Preferably the adhesive is located in areas where the frame 12 comes into contact with the second door skin 30. In exemplary embodiments, the adhesive is applied to the door skin 30 (rather than the frame 12) because it is easier for a robotic glue dispensing and the application temperature may be sufficiently high as to cause the adhesive to be evenly pressed and distributed onto surfaces 19 between the second interior skin 33 and frame 12 (see FIG. 6). So alternatively, this adhesive may be different from the one applied to the core inserts 40 and lock block 42.

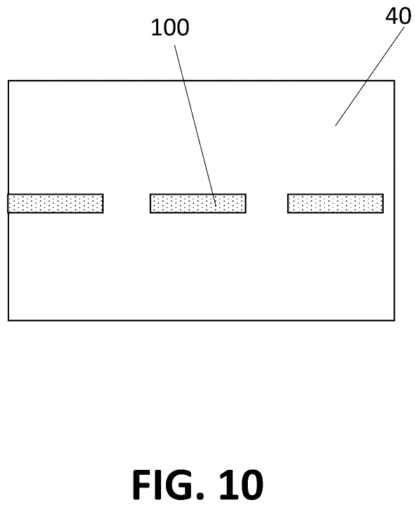

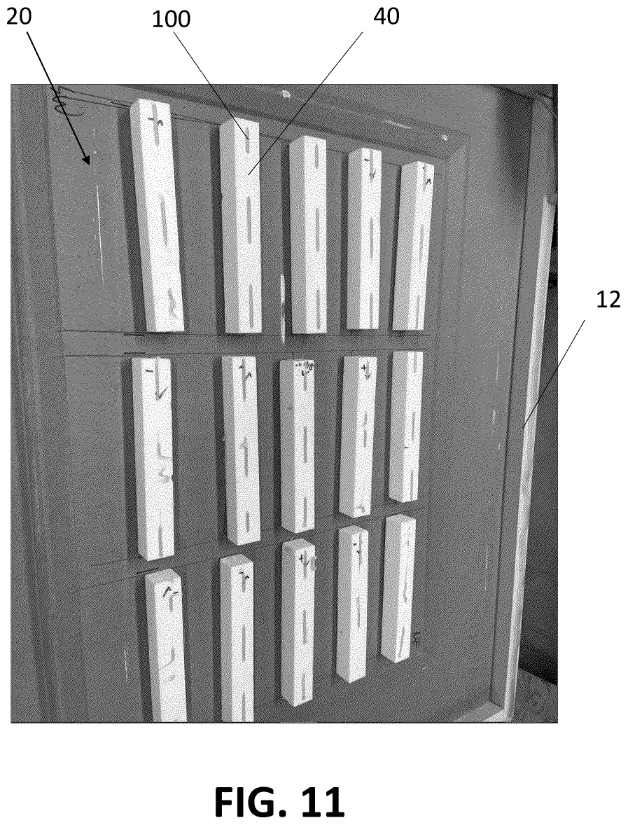

At the same time of adhesive application to the second interior surface 33, the adhesive may also be optionally applied to the core inserts 40 and lock block 42 in preparation for assembly with the second door skin 30. As shown in FIGS. 10-11, the adhesive is in exemplary embodiments applied on the surface 33 as a single line 100 of adhesive. The line or bead 100 preferably has a height from the surface of the surface 33 of about 0.06 to about 0.09 in. and a weigh of about 0.15 to about 0.30 g/in. The line 100 is preferably positioned on the center line of the length of the application area as a broken line to reduce the amount of adhesive used. Although FIG. 10 shows three segments to the broken line 100, the line 100 may have more or less than three segments, e.g., two, four, five, etc., with each segment preferably having a length of about 2 in. or longer. In exemplary embodiments, multiple shorter beads of 50-100% of the core insert 40 length are adequate. This not only saves on adhesive cost, but also on the total pump capacity needed to supply the nozzles.

In exemplary embodiments, a preferred adhesive to form the line 100 is a polyurethane reactive (PUR) adhesive, e.g., available commercially as Rapidex® 4001 or Rapidex® 1008 from H.B. Fuller. Preferred PUR adhesives have a viscosity about 9500 cP, an open time (time to allow bonding the two substrate surfaces together before the adhesive starts to form a skin that will lead to bonding failure) of 3-4 minutes and a temperature of 265-285° F.

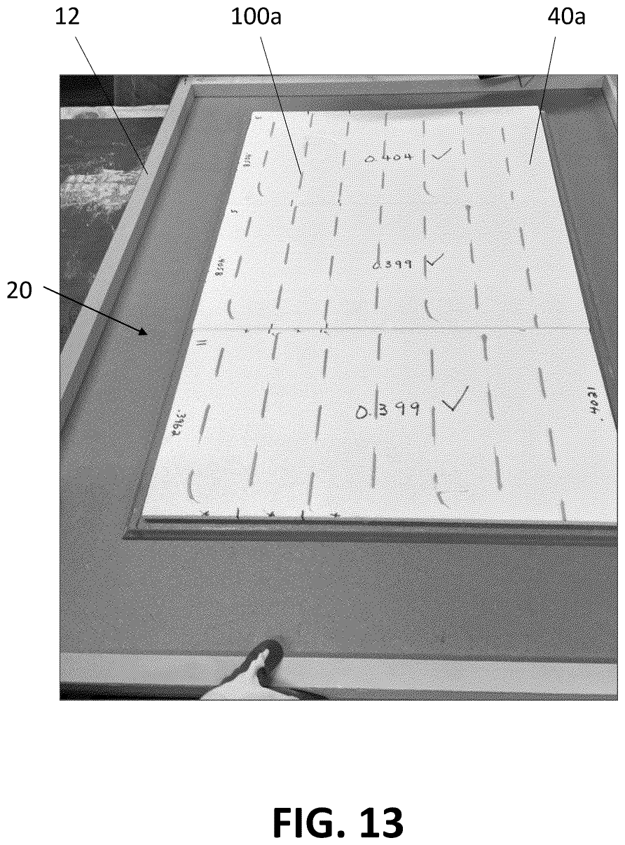

In another exemplary embodiment, as shown in FIG. 13, the recessed panel region of the first door facing 20 may be substantially filled with a large EPS single core insert 40a with a lower nominal thickness of about ⅜ in. instead of a plurality of smaller core inserts 40. Because the single core insert 40a is larger, several adhesive lines 100a are used to adhere the core insert 40a to the second door skin 30. In an exemplary embodiment, the glue lines are spaced 3 in. apart from the left to the right edges of the core insert 40a. Each of the adhesive lines 100a, as shown in FIG. 13, is a broken line having several segments to reduce the amount of adhesive used. The preferred height and weight of the lines 100a is the same as described above for the line 100.

It can be seen in FIG. 13 that multiple adhesive lines 100a are disposed in an exemplary spaced, parallel array. In exemplary embodiments, it can be advantageous to have the lines 100a slightly offset in the longitudinal direction, with a segment of a line 100a of a first line 100a starting and stopping offset relative to the adjacent lines 100a. The lines 100a may be applied through a robotic glue dispensing application.

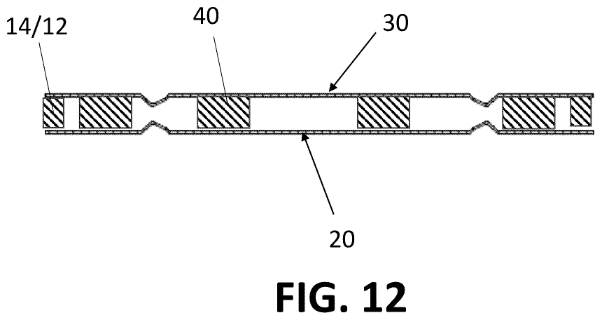

As shown in FIG. 12, the second door skin 30 is then placed on the frame 12 (with the adhesive on the door skin 30). In exemplary embodiments, the second door skin 30 is placed on the frame 12 about 30-40 seconds after application of the adhesive with a slight compressive force of no more than 2-3 psi. As noted previously, the core insert(s) 40 has the same nominal thickness t (see FIG. 4) of the frame 12. Due to thickness variability, a small gap may exist between the core insert(s) 40 and the second door skin 30 when the door skin 30 is placed on to the frame 12. In exemplary aspects described herein, however, the line(s) 100 of adhesive on the surface 33 efficiently fill the gap while the adhesive achieves green strength to maintain a flat door skin (with minimal distortion). The adhesive adheres the second door skin 30 to the second surface 19 of the frame 12 to form a complete door 10. In exemplary embodiments, the placement of the second door skin 30 and conveyance to the next step (pressing) is preferably in about 40-55 seconds, which allows the adhesive to achieve adequate green strength.

The complete door assembly is then pressed in a press to allow pressure to be applied to the door 10 to facilitate securing the frame 12 (along with the core insert(s) 40 and lock blocks 42) to the associated door facings 20, 30. In the press, the adhesive is pressed to achieve sufficient green bonding strength. In exemplary embodiments, the door 10 is pressed at about 98 to about 102 PSI for about 4 to about 5 seconds. The lines 100 of adhesive fill the gap between the second door facing 30 and the core inserts 40 to sufficiently support the door facing 30 so that the door 10 surfaces remain flat after pressing (i.e., the surfaces are not deformed).

After the door 10 has adequately cured, it then may pass through a number of optional finishing operations as needed. For example, the door 10 may be trimmed to size. The door 10 may be passed through a stile and rail trimming station to remove excess material. After the edges have been trimmed, the door may be placed through an edge coating station where the edges of the door 10, such as the exposed rails 16, 17 and stiles 14, 15, are coated or painted. The door 10 may also be subjected to other painting or coating.

Unless otherwise indicated, the adhesive is preferably a hot melt adhesive, such as PUR. The hot melt adhesive achieves green strength in a very short amount of time to secure the bond between the door skin(s), the frame, and the core inserts and to allow the assembly process to quickly proceed from one step to the next. In an exemplary embodiment, a PUR adhesive comprising polyurethane and isocyanate is used.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to necessarily limit the invention to the precise embodiments disclosed.

We claim:

1. A method of assembling a door, comprising:
applying a first adhesive to a first surface of a frame including first surfaces of plural stiles and rails;
assembling the first surface of the frame, including the stiles and rails, on an interior surface of a first door skin to assemble a half door, wherein the first adhesive is a hot melt adhesive configured to achieve green strength within a predetermined time to prevent movement of components relative to one another;
pressing the half door;
applying a second adhesive to the interior surface of the first door skin;
positioning a first surface of one or more core inserts, lock blocks or locking components on the second adhesive on interior surface of the first door skin;
applying a third adhesive to an interior surface of a second door skin or to a second surface of the frame and the one or more core inserts, lock blocks or locking components;
placing the second door skin on the frame to form a complete door assembly; and
pressing the complete door assembly.

2. A method in accordance with claim 1, wherein the first adhesive is roller coated onto the first surface of the frame.

3. A method in accordance with claim 1, wherein the first adhesive is provided as a film coating.

4. A method in accordance with claim 1, wherein the first adhesive is spread over the entire first surface of the frame.

5. A method in accordance with claim 1, wherein one or all of the first, second, and third adhesives are a polyurethane reactive (PUR) adhesive.

6. A method in accordance with claim 5, wherein the PUR adhesive has a viscosity of about 9500 Centipoise (cP), an open time of 3-4 minutes and is applied at a temperature of between 265 and 285 degrees Fahrenheit.

7. A method in accordance with claim 1, wherein the frame, including stile and rail components are applied to the interior surface of the first door skin by a robot.

8. A method in accordance with claim 1, wherein a first surface of plural core inserts are applied to the interior surface of the first door skin having second adhesive thereon by a robot.

9. A method in accordance with claim 1, wherein the half door is pressed in a press under pressure at about 100 pounds per square inch (PSI) for a predetermined period of time for the first adhesive to develop green strength in order to maintain the first skin and the frame in position during further door assembly.

10. A method in accordance with claim 1, wherein the third adhesive is applied to an interior surface of a second skin using robotic glue dispensing.

11. A method in accordance with claim 1, wherein the third adhesive is applied as plural single line or bead of adhesive using robotic glue dispensing.

12. A method in accordance with claim 11, wherein the line or bead of the third adhesive has a height from the interior surface of the second door skin of between about 0.06 and 0.09 inches and a weight of about 0.15 to 0.30 grams per inch (g/in).

13. A method in accordance with claim 11, wherein the line or bead is applied on the center line of the length of the application area as a broken line by one or more robotic glue dispensing nozzles.

14. A method in accordance with claim 11, wherein the line or bead is applied to the second surface of plural core inserts as multiple beads having a length of 50-100 percent of the length of the core insert on which a bead is being applied by one or more robotic glue dispensing nozzles.

15. A method in accordance with claim 1, the first door skin includes at least one recessed panel that is filled with a large single core insert, wherein plural spaced adhesive lines or beads are provided on the second surface thereof by one or more robotic glue dispensing nozzles.

16. A method in accordance with claim 15, wherein the plural spaced adhesive lines or beads are disposed in a parallel array.

17. A method in accordance with claim 16, wherein the lines or beads are offset in the longitudinal direction.

18. A method in accordance with claim 1, wherein the second door skin is placed on the frame between 30 and 40 seconds after application of the third adhesive with compressive force of between 2 and 3 PSI.

19. A method in accordance with claim 18, wherein the time between placement of the second door skin and conveyance to the press is between 40 and 55 seconds.

20. A method in accordance with claim 1, wherein the assembly is an automated assembly using one or more robotic components, component conveyances and presses.
